(19) United States
(12) Patent Application Publication
(10) Pub. No.: US 2014/0225391 A1
(43) Pub. Date: Aug. 14, 2014

(54) GRIPPING OR CLAMPING DEVICE AND METHOD FOR HANDLING ARTICLES

(71) Applicant: J. SCHMALZ GMBH, Glatten (DE)

(72) Inventors: Harald Kuolt, Deilingen (DE); Florian Fritz, Tuebingen (DE); Thomas Eisele, Alpirsbach-Peterzell (DE)

(73) Assignee: J. SCHMALZ GMBH, Glatten (DE)

(21) Appl. No.: 14/342,624

(22) PCT Filed: Sep. 6, 2012
(86) PCT No.: PCT/EP2012/067399

§ 371 Date: Mar. 4, 2014

(30) Foreign Application Priority Data
Sep. 7, 2011 (DE) 10 2011 082 301.8

(51) Int. Cl. B25J 15/06

(52) U.S. Cl. CPC B25J 15/0683; B25J 15/0616
USPC 294/183

(57) ABSTRACT

The present invention relates to a gripping device for holding articles in place, including a base that has a receiving surface that faces an article for holding it in place, the base having at least one passage guide that leads to a passage opening in the receiving surface, and the receiving surface has at least one nanostructure portion on which a plurality of nanostructure elements are arranged.

### CROSS-REFERENCE TO RELATED APPLICATIONS

This is a “national stage” application of International Patent Application PCT/EP2012/067399 filed on Sep. 6, 2012, which, in turn, is based upon and claims priority to German Patent Application 10 2011 082 301.8 filed on Sep. 7, 2011.

### BACKGROUND OF THE INVENTION

1. Field of Invention

The invention relates to gripping and clamping devices for holding articles in place, as well as methods for handling articles.

2. Description of Related Art

Gripping and clamping devices known in the art typically have a receiving surface that is turned towards an article for holding the article in place. For example, in the case of suction grippers, a vacuum guide leads to a suction opening in the receiving surface through which an article can be suctioned to the receiving surface.

Gripping or clamping devices known in the art often have significant energy requirements. This can be attributed to flow resistances of the suctioned air through the suction opening. Further, in the case of a suction gripper, it is necessary in some circumstances to maintain the vacuum so as to keep the article held in place. This can likewise require an additional expenditure of energy. An additional problem lies in the fact that the receiving surface can get a gripping or clamping device very dirty with frequent use, in particular because of dust deposits. As a result, the reliability of the gripping or clamping device is impaired. For example, in the case of a suction gripper, a sealing contact of the suction body to the article to be gripped can be made more difficult. Moreover, to increase the reliability it is desirable to determine whether an article of the gripping or clamping device is held in place.

The present invention addresses the problem of supporting the handling process of an article and reducing the disadvantageous effects discussed above. In particular, an energy-saving and reliable handling of articles is made possible.

### SUMMARY OF THE INVENTION

The gripping or clamping device of the present invention has a base with a receiving surface which is turned towards an article for the purpose of holding the article in place. The base also has a passage guide that leads to a passage opening in the receiving surface. Further, the receiving surface of the gripping or clamping device has at least one nanostructure portion with a plurality of nanostructure elements arranged on it.

Through the passage opening in a case of the present invention, fastening forces can be exerted on the article to be held in place (for example, suction forces) Likewise, other functions can be provided through the passage opening (for example, a release force can be exerted for release of a fastened article). The passage opening is designed such that a gaseous medium can flow through. For example, a design in which gas is suctioned through the passage opening from the side of the receiving surface facing the article to be held in place is conceivable (intake opening). Also possible is a design in which the gas can be blown through the passage opening to the article (in particular as a Bernoulli nozzle or as an air discharge opening).

The nanostructure portion can extend over the entire receiving surface or can extend only in sections over the receiving surface. The base can be designed such that the receiving surface is deformable and can lie on an article when it is held in place. However, the receiving surface can also be designed rigid. With the receiving surface of the present invention, with the nanostructure elements of the nanostructure portions, various advantageous effects can be achieved. For example, the nanostructure portion can be arranged on the (rigid or deformable) receiving surface such that the nanostructure portion can come into contact with the article in the event of the article being held in place. The nanostructure elements are designed such that in the event of contact of the nanostructure portion with the article, static friction forces on the article are increased (compared to contact between the article and receiving surface in the region of the nanostructure portion without nanostructure elements). The nanostructure elements are designed such that in the event of contact an adhesive force can be exerted (for example, being achieved using Van-der-Waals forces). This makes it possible to save money in the operation of the device (for example, a vacuum device can be switched off after holding the article in place).

In one embodiment, the nanostructure elements are designed as rod-type (pencil shaped) or in the form of bristles protruding from the nanostructure portion of the receiving surface. If the article to be held in place comes into contact with such a nanostructure portion, the rod or pencil shaped nanostructure elements lie against the surface of the article as brush hairs and do not touch it with their (small) abutting surfaces, but rather with at least one portion of their (large) lateral surface. As a result a considerably enlarged contact surface is created, which can lead to greater adhesive forces (e.g. Van der Waals forces). Possible designs of the nanostructure elements will be explained in greater detail below.

In one embodiment, the nanostructure portion can also be arranged such that a gas flow passing through the passage opening (for example, compressed or suctioned air) can be guided from the nanostructure portion in sections. The nanostructure elements are designed such that the flow resistance of the gas flow is lowered in the event of the guidance of a flow along the nanostructure portion (compared to gas flow guidance in the region of the nanostructure portion without nanostructure elements). By lowering the flow resistance, it is possible to conserve energy. In one embodiment, the nanostructure elements are designed as rib-like or scale-like such that the flow resistance compared to the nanostructure portion is lowered when a turbulent gas flow flows around said nanostructure portion. This is based on the so-called “sharkskin effect” known in the art.

In order to achieve a reduction of the flow resistance, at least one nanostructure portion can be arranged in the region of the passage opening on the receiving surface, or in the mouth region of the passage opening.

In one embodiment, the nanostructure portion is designed to be electrically conductive such that the electrical conductivity of the nanostructure portion changes depending on a pressure acting on the nanostructure portion. This can be achieved by inserting carbon nanotubes into the material of the nanostructure portion (which includes a non-conducting plastic), as layers. Such composite materials may have electrical properties that can be influenced by pressure acting on the material and/or a mechanical deformation of the material. The present invention makes tactile gripping or clamping of an article possible. In this way, it can be recognized whether sufficient vacuum can be established in the case of a vacuum gripping device or clamping device in the event of the presence of a workpiece. However, a response to purely mechanical pressure is also conceivable. The nanostructure portion is in the process arranged such that it can come into contact with an article in the case of the article being held in place. Further, the present invention permits detection of whether compressed air is flowing through the passage opening.

The pressure dependence of the electrical conductivity of the nanostructure portion can be achieved by a corresponding design of the nanostructure elements. In this respect, the nanostructure elements are designed such that the electrical properties of the nanostructure portion (for example, conductivity) change depending on pressure acting on the nanostructure portion.

Further, the nanostructure portion may have measurement contacts for measurement of the electrical conductivity. It is also conceivable that the device may include electrical conductivity measurement connected electrically to the measurement contacts.

In one embodiment, the nanostructure elements is designed such that a deposit of undesirable dirt particles at or on the nanostructure portion is prevented or reduced. The form of the nanostructure elements is designed such that the mentioned effect is achieved for particles with particle diameters ranging from 1 micrometer (fine dust) to 100 micrometers (coarse dust). A so-called “lotus effect” can be achieved by designing the nanostructure elements as papillae or suppositories, which can have a height ranging from several hundred nanometers to 20 micrometers and be arranged at a distance of likewise several hundred nanometers to 20 micrometers to one another. An additional cause of dirt deposits can be an electrostatic charging of the receiving surface. This can be prevented or at least reduced by designing the nanostructure portion or the nanostructure elements themselves to be electrically conductive. As explained, carbon nanotubes can be used.

The passage opening does not necessarily have to serve the purpose of conducting a gaseous medium, such as compressed air. In particular, it is advantageous for the handling of articles in the vacuum when a fixing in place or holding of the article only occur by the adhesive forces on the article introduced by the nanostructure portions.

An advantageous design arises because the device is designed as a vacuum gripping device or clamping device, wherein the base is designed as a suction body and the pass opening is designed as a vacuum guide. In operation, the receiving surface limits a suction chamber that can be evacuated through the passage opening when an article for holding in place is in contact with the suction body. The inventively designed vacuum gripping device or clamping device can be used to save energy. With the nanostructure portion, it is possible to reduce the flow resistance in the region of the passage opening as described above. As a result, the energy requirements of the vacuum gripping device or clamping device are reduced when idling. Moreover, the nanostructure portion can support the retaining forces as described through adhesion. The reliability of the device can be increased by using corresponding nanostructure elements to prevent a soiling of the receiving surface as described above. Further, in the case of corresponding design it is possible via the change of the electrical properties of the nanostructure portion to reliably detect whether an article is being gripped or held in place.

The suction body is designed to be deformable (in particular, flexible) so that the receiving surface can come into contact at least in sections with the article to be held in place in the case of a vacuum prevailing in the suction chamber. The nanostructure portions are arranged in the contact region of the receiving surface.

The present invention can also be designed as a Bernoulli gripper, as is known in the prior art (see: DE19948572A1, DE10319272A1, EP1429373A, EP0026 336A, U.S. Pat. No. 4,566,726A, DE102009047083A1). In the case of grippers known in the art, the passage opening is designed as an exhaust opening. The exhaust opening is designed as a nozzle (or acts as one) so that by air expulsion, a suction effect can be exerted on the article to be held in place. Through the nanostructure portion arranged on the receiving surface, it is possible to reduce flow resistances in the region of the exhaust opening and thus making possible an energy saving and reliable operation of the Bernoulli gripper.

However, the passage opening can be designed as a blow opening or blow-off nozzle for a fixed article. To this end, the device has a pressure connection, to which the passage guide is flow connected. The passage opening is designed such that by the flow of a gas (for example, compressed air) through the passage opening to the article side a release force can be produced for the release of a fixed article. An article held in place on the nanostructure portion adhesion can be purposefully released. However, a release force can also be exerted mechanically. To this end, the device can have a displaceable tappet or piston. The piston can be displaced in the passage opening of the base between a release position (in which a section of the piston protrudes through the passage opening over the receiving surface, and a retracted position).

The nanostructure elements have a structural length (height, width, distance from one another, edge length), wherein the structural length lies in the region of between 10 nanometers or 1000 nanometers. The nanostructure elements can be regularly arranged on the nanostructure portion at intervals that correspond to the structural length (for example, extension) of a nanostructure element or be in the same order of magnitude. However, an irregular arrangement is also conceivable, with average distances in the order of magnitude of the named structural length. For example, the nanostructure elements may be be cylindrical, conical, pyramid-shaped or rod-shaped in design with a base area and a structural height measured perpendicular to the base area, which lies in the region of 10 nanometers to 1000 nanometers. Such nanostructure elements are connected over their respective base area to the nanostructure element or the receiving surface, in one piece. However, the nanostructure portion can be detachably fastened to the receiving surface (for example, as an adhesive foil).

In embodiments of the present invention, the nanostructure elements may include carbon nanotubes, include sections of carbon nanotubes, or may be designed as carbon nanotubes. The nanotubes can be arranged such that they protrude in the form of bristles from the nanostructure element. This makes it possible for the carbon nanotubes to deflect in a bristle-like manner and, with their long lateral sections, at least partially be in contact with the article to be held in place. As a result, a considerably enlarged and effective contact surface is created, and a great adhesive force is facilitated. However, the carbon nanotubes can also be at an angle to the surface of the nanostructure portion, or be arranged as a tile, in order to achieve a reduction of the flow resistance. Further, the carbon nanotubes can be arranged in layers on or in the nanostructure portion, in order to achieve a pressure-dependent electrical conductivity of the nanostructure portion.

The initially set task is moreover solved by a method for handling articles, in particular for gripping or clamping articles. In operation, a receiving surface facing an article is provided first, the receiving surface having at least one nanostructure portion, at which a plurality of nanostructure elements are arranged. For the purpose of holding the article in place, contact is established between at least one nanostructure portion and the article. As a result, the article can be held in place by adhesive forces introduced to the receiving surface via the nanostructure element. To release the fixed article from the receiving surface, a gas (in particular, compressed air) is emitted through a passage guide that leads to a passage opening in the receiving surface. Since the discharge takes place through the passage opening in the receiving surface, reliable handling is made possible. The holding of the article fixed in place in the receiving surface itself takes place due to adhesive forces and, therefore, does not require additional energy.

In one embodiment, a suctioning of the article to be held in place takes place through the passage opening in the receiving surface. As a result, contact can be established between the at least one nanostructure portion of the receiving surface and the article. In the case of a suitable design of the nanostructure elements for exerting an adhesive force, the article can be held in place on the receiving surface.

The method is improved by the fact that after establishment of contact between the article and the nanostructure portion, a further suctioning of the article through the passage opening is prevented. To this end, a detection of the establishment of the contact takes place by a change in the conductivity of the nanostructure portion on the basis of the mechanical pressure through the suctioned article, as discussed above. The suctioning is then prevented because of the detection of contact. As a result, energy can be saved. Also, this handling method is further developed due to the fact that a release force to release the fixed article is generated because a gas (in particular, compressed air) is emitted through the passage opening.

### BRIEF DESCRIPTION OF THE DRAWINGS

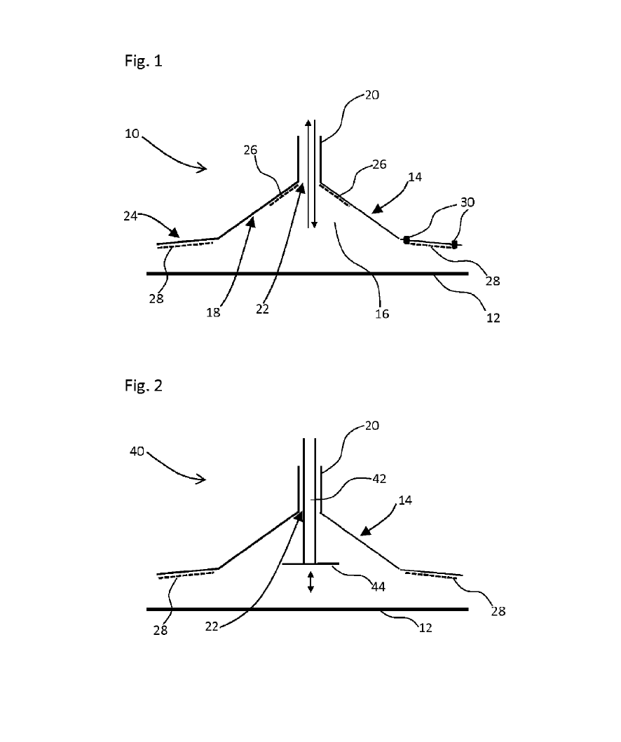

For further explanation of the foregoing general description of the invention, in the following the embodiments of the invention outlined in FIGS. 1 and 2 will be described in greater detail.

### DETAILED DESCRIPTION OF THE INVENTION

FIG. 1 shows a suction gripper 10 for the gripping and holding in place of a workpiece 12. The suction gripper 10 has a suction body 14 made of an elastically deformable material (in particular, plastic). The suction body 14 is designed such that a suction chamber 16 is limited, said suction chamber being able to be evacuated in the event of the workpiece 12 coming into contact with the suction body in order to hold the workpiece 12 in place via suction. The suction body 14 has a receiving surface 18 limiting the suction chamber 16. Further, a passage guide 20 penetrating the suction body 14 at least in sections is provided, which leads to a passage opening 22 in the receiving surface 18. With the adjoining workpiece 12, the suction chamber 16 can be evacuated through the passage guide 20 for the purpose of suctioning the workpiece 12, to which end the passage guide 20 can be connected to a vacuum connection not described in greater detail. The suction body 14 has a sealing lip section 24 for sealing contact of the suction body 14 with its receiving surface 18 on the workpiece 12. The sealing lip section likewise adds to the receiving surface 18. In addition, various nanostructure portions 26 and 28 are arranged on the receiving surface 18. First nanostructure portions 26 are arranged on the receiving surface 18 in the region of the passage opening 22. Second nanostructure portions 28 are provided on the sealing lip sections 24 of the receiving surface 18.

The first nanostructure portions 26 have nanostructure elements which are designed such that the flow resistance of a gas flow flowing through the passage opening 22 (for example, compressed air or air suctioned from the suction chamber 16) is reduced. Further, the nanostructure portions 28 have nanostructure elements which are designed for exerting an adhesive force on the workpiece 12 when the sealing lip section 24 comes into contact with the workpiece 12.

The workpiece 12 can be gripped by placing the sealing lip section 24 of the suction body 14 on the workpiece 12 and evacuating the suction chamber 16 through the passage opening 22. As a result, the nanostructure portions 28 are pressed on the surface of the workpiece 12. On the basis of the design of the nanostructure elements of the nanostructure portion 28, an increased static friction force or adhesive force then acts between the sealing lip section 24 and the workpiece 12. As a result, a lateral shifting of the workpiece 12 can be prevented and the adhesive force supports a fixation of the workpiece 12 on the suction gripper 10.

The adhesive force applied from the nanostructure portion 28 makes it possible switch off the vacuum supply of the suction chamber 16 after gripping the workpiece 12. The workpiece 12 then remains fixed on the nanostructure portion (if applicable) solely due to the adhesive forces. In order to remove the workpiece 12 from the suction gripper 10, compressed air can be blown in through the passage guide 20 into the suction chamber 16. As a result, a release force from the nanostructure portion 28 is exerted on the workpiece 12. The suctioning or discharge though the passage opening 22 is represented by arrows in FIG. 1.

An alternative possibility for releasing the workpiece 12 from the nanostructure portions 28 is outlined in FIG. 2 on the basis of a suction gripper 40. In FIGS. 1 and 2, the same reference numbers are used for identical components or components that correspond to one another. The suction gripper 40 has a piston 42 for releasing the workpiece 12, the piston being displaceable in a release position such that the workpiece 12 can be pushed away from the nanostructure portion 28 by a contact section 44 of the piston 42.

The nanostructure portions 26, 28 may be designed to be conductive, wherein the conductivity changes on the basis of pressure acting on the nanostructure portion 26, 28. The pressure can be mechanical (for example, contact of the workpiece 12 on the nanostructure portion) or attributable to gas pressure (for example, a vacuum prevailing in the suction chamber 16). Shown by way of example in FIG. 1, for the suction gripper 10, the nanostructure portion 28 has two measurement contacts 30 for conductivity measurement. This makes it possible to detect a change in conductivity on the basis of a contact of the workpiece 12 on the sealing lip section 24. Corresponding designs are also possible for other nanostructure portions 26.

1. A gripping device for holding articles in place, comprising a base which has a receiving surface that faces an article for holding it in place, the base having at least one passage guide that leads to a passage opening in the receiving surface, and the receiving surface has at least one nanostructure portion on which a plurality of nanostructure elements are arranged.

2. The device as set forth in claim 1, wherein the nanostructure portion is arranged such that it can come into contact with an article in the case of said article being held in place, wherein in the event of contact adhesive forces can be generated between the nanostructure portion and the article.

3. The device as set forth in claim 1, wherein the nanostructure portion is arranged such that a gas flow passing through the passage opening can be guided from the nanostructure portion at least in sections, wherein the flow resistance of the gas flow is lowered in the event of the guidance of a flow along the nanostructure portion.

4. The device as set forth in claim 1, wherein the nanostructure portion is electrically conductive such that the electrical conductivity of the nanostructure portion changes depending on a pressure acting on the nanostructure portion (26, 28).

5. The device as set forth in claim 1, wherein the nanostructure elements prevent a deposit of dirt particles, in particular with particle diameters ranging from 1 micrometer to 100 micrometers.

6. The device as set forth in claim 1, wherein the device is one of a vacuum gripping device or clamping device, wherein the base is a suction body such that the receiving surface limits a suction chamber that can be evacuated through the passage opening when an article for holding in place is in contact with the suction body.

7. The device as set forth in claim 6, wherein the suction body is deformable, such that the receiving surface can come into contact with the article to be held in place in the case of a vacuum prevailing in the suction chamber.

8. The device as set forth in claim 1, wherein the device has a pressure connection and that the passage guide is flow connected to said pressure connection, and that by the flow of a gas through the passage opening (22) a release force can be produced for the release of a fixed article (12).

9. A method for handling articles including the steps of,
providing a receiving surface facing an article, said receiving surface having at least one nanostructure portion, at which a plurality of nanostructure elements are arranged,
establishment of contact between the at least one nanostructure portion and the article such that the article (12) can be held in place by adhesive forces introduced to the receiving surface via the nanostructure element,
emission of a gas through a passage guide that leads to a passage opening in the receiving surface to release the fixed article from the receiving surface.

10. A method for handling articles including the steps of,
providing a receiving surface facing an article, said receiving surface having at least one nanostructure portion, at which a plurality of nanostructure elements are arranged,
a suctioning of the article to be held in place through a passage opening in the receiving surface such that contact can be established between the at least one nanostructure portion and the article and the article is held in place on the receiving surface.
